(19) United States
(12) Patent Application Publication
(10) Pub. No.: US 2015/0058505 A1
(43) Pub. Date: Feb. 26, 2015

(54) METHOD FOR OPERATING A BUFFER MEMORY OF A DATA PROCESSING SYSTEM AND DATA PROCESSING SYSTEM

(71) Applicant: CONTINENTAL AUTOMOTIVE GMBH, HANNOVER (DE)

(72) Inventors: ANDRE GOEBEL, REGENSBURG (DE); RALPH MADER, BAD ABBACH (DE); OVIDIU TRIPON, TIMISOARA (RO)

(21) Appl. No.: 14/466,058

(22) Filed: Aug. 22, 2014

(30) Foreign Application Priority Data
Aug. 22, 2013 (EP) 13181351

(51) Int. Cl. G06F 5/06

(52) U.S. Cl. CPC G06F 5/065; G06F 2205/067
USPC 710/56

(57) ABSTRACT

A method of operating a buffer memory of a data processing system on which two or more programs can run in parallel includes the following: a source code is generated for a program to be executed and the needed data of the program to be executed are stored in the buffer memory; at least one address register is simultaneously generated, with the memory content of the address register being addresses of each of the two or more programs in the buffer memory. The two or more programs in the buffer memory are accessed via the at least one address register.

### CROSS-REFERENCE TO RELATED APPLICATION

This application claims the priority, under 35 U.S.C. §119, of European patent application EP 13181351, filed Aug. 22, 2013; the prior application is herewith incorporated by reference in its entirety.

### BACKGROUND OF THE INVENTION

### Field of the Invention

The invention relates to a method of operating a buffer memory of a data processing system by way of which the access of programs, running on the data processing system, to a buffer memory, in which data of another program executed are stored, is controlled.

In data processing systems, fast buffer memories are used between a central processing unit and a system memory for enhancing the performance. These buffer memories achieve their high effectiveness by virtue of the processors accessing memory addresses frequently in short succession several times.

In conventional data processing systems, multi-core processors are being used more and more which combine a number of cores in one processor. In multi-core processors, many tasks are divided into processes. These tasks are processed in parallel by a number of processor cores by programs running on the processor cores.

Furthermore, conventional operating systems of a data processing system are capable of providing for so called multitasking, that is to say calling up a number of programs simultaneously and controlling their sequence. Integrated into this control function are, for example, the representations of the respective operating state and/or the results on a display unit connected to the data processing system or another output unit, the retrieval of data needed for the respective program running, the storage of intermediate and/or final results, the assignment of needed resources and a notification of any error messages of predetermined destinations. Furthermore, the transmission of data which are produced by a program in another process to another computer system, to a network or to a server as part of the problem definition of the respective process may become necessary or be a component of the original function.

In this context, a number of programs are processed in each case in such data processing systems in a separate data area and with their own data without entering into an interaction with one another. Each program has its own sequence consisting of stringing together a multiplicity of steps which provides for a proper progress or a corresponding message of a disturbance of this proper progress and the fulfillment of the task in each case allocated to the program.

For example, in the environment of medical technology or in the case of control devices of a motor vehicle, a number of programs or also subprograms can be used for processing any total program of a data processing system, however. From the point of view of the operating system, a process, which is also called a task, is in this case an integral sequential unit which is represented by a program or a program section. In this context, situations may occur in which a program or subprogram must access data which are produced by a program in another process and are stored in a buffer memory of another program.

German patent DE 42 36 820 C2 describes a multitasking data processing system in which the access to a buffer memory is administered internally via pointers.

### SUMMARY OF THE INVENTION

It is accordingly an object of the invention to provide a method of operating a buffer memory of a data processing system and a data processing system which overcome the disadvantages of the heretofore-known devices of this general type and which provide for a particularly need-oriented access to a buffer memory in a particularly simple manner also from changing processes or programs, respectively.

With the above and other objects in view there is provided, in accordance with the invention, a method of operating a buffer memory of a data processing system that is configured to run two or more programs in parallel. The novel method comprises the following steps:

generating a source code for a program to be executed and storing needed data of the program to be executed in the buffer memory;

simultaneously generating at least one address register, the memory content of which are addresses of each of the two or more programs in the buffer memory; and

accessing the two or more programs in the buffer memory via the at least one address register.

In other words, the objects of the invention are achieved by a method for operating a buffer memory of a data processing system on which two or more programs can run in parallel. In this context, the method exhibits the following steps: a source code is generated for a program to be executed and needed data of the program to be executed are stored in the buffer memory. Simultaneously, at least one address register is generated, the memory content of which are addresses of each of the two or more programs in the buffer memory. Subsequently, the two or more programs in the buffer memory are accessed via the at least one address register.

The basic concept is thus to generate, at the latest before the execution of a program, an address register from which the basic address of the buffer memory, in which needed data of the program to be executed are stored, can be read.

Such a method has the advantage that a particularly need-oriented access to a buffer memory is provided for in a particularly simple manner also from changing processes or programs, respectively. On the basis of the two or more programs a fast access of the two or more programs to the data stored in the buffer memory in one step is thus guaranteed by the addressing of the buffer memory via the at least one address register, especially also a fast access of the program to Pdata of a further program. Furthermore, this access is optimized during this process with regard to resource consumption and computing time of the data processing system. Thus, processors which have a common address and data collection line system, which is called bus, execute instructions sequentially. In the case of internal buffer management via pointers, an instruction address, placed on the bus, is first stored in an address register. Subsequently, the instruction addressed is read into the processor with a time delay depending on the access time of the system memory. During the subsequent execution of these instructions in the processor, data addresses and the data themselves are input or output, respectively, via the same bus. A not inconsiderable workload of the bus is thus associated with instruction addresses which leads to a frequently considerable extension in time of the processing of program sequences. Fast address management in the form of address registers are also commonly used in information or digital technology, particularly in the area of microcontrollers, and designate a database which is intended for inputting addresses, and a database with simple search functions. This can be implemented rapidly and in a simple manner so that it can be achieved in a simple manner and without great expenditure in this case.

According to one embodiment, the data processing system can be a preemptive and/or cooperative multitasking data processing system. Operating systems which operate in multitasking—or multiprocess operation, respectively, execute a number of tasks, that is to say processes, concurrently. The methods used as a standard in this context are the cooperative multitasking and the preemptive multitasking in which an operating system core controls the processing of the individual processes and stops each process in favor of other processes after a particular processing time. By means of the at least one address register, it can be guaranteed in this context that a program which is used for implementing a process can access data of a further program rapidly and in real time even if it has been stopped in favor of other processes, it being possible to save resources and computing time in comparison with an internal memory management via pointers which takes place usually at the precise time when the data are needed.

According to another embodiment, the data processing system can also comprise a multi-core processor. In the multi-core processor system, many processes are divided into tasks. These tasks are processed in parallel by a number of processor cores. In this context, situations may occur in which a task is dependent on another task, that is to say situations in which a program which is used for implementing a task, needs to access the data of another program processed on a processor core of the multi-core processor. Using the at least one address register makes it possible to ensure again a rapid and real-time access to these data, it being possible to again save resources and computing time in comparison with an internal memory management via pointers.

The data processing system can also have a real-time operating system. In a real-time system, a number of tasks run with different priorities, as a rule, and must be executed in real time. In consequence, it is necessary particularly in real-time operating systems and real-time operating system cores that the communication of programs, that is to say the tasks, is prompt and fast, especially that the individual programs can access data of further programs rapidly and reliably without, for example, delays occurring.

Furthermore, the at least one address register can then be stored in the context memory which is accessed by the two or more programs. It is a characteristic of a process that it always accesses its own memory area. A process consists of a number of threads which are program sections of a process. A context of a thread is the processor status of a processor which processes this thread or program commands of this thread. Accordingly, the context of a thread is defined as a temporary processor status during the processing of the thread by this processor. The context is held by the hardware of the processor, namely the program counting register or program counter, the register file or the context memory, respectively, and the associated status register. The individual programs thus access only the context memory and the at least one address register independently of the selected operating mode or the selected operating system, respectively. It is then possible to access the memory unit, that is to say the buffer memory, directly via the at least one address register. This requires correspondingly few clock steps and therefore accelerates the flow of the process further, that is to say the access of the two or more programs to the buffer memory.

In this arrangement, the buffer memory can be constructed of buffer rows. Furthermore, the two or more programs can access the buffer memory in reading and/or writing manner, in such a manner that the same Pdata from the two or more programs are in each case written into the same buffer row. As a result, a memory coherence can also be ensured. Ensuring coherence prevents different, inconsistent data from being supplied back for the same memory address. In this context, buffer memories use blocks of data called buffer rows which almost always amount to a multiple of a word width of the processor and frequently even amount to a multiple of the width of the bus connecting the processors with a system memory.

The content of the buffer memory can also be written into a system memory of the data processing system after completion of the program to be executed. As a result, it is possible to ensure that in the case of a restart of the corresponding program, the individual program sections, that is to say the associated program data are present in the last version used, it being possible to use the bus between processor and system memory without resulting in a not inconsiderable loading of the bus.

With the above and other objects in view there is also provided, in accordance with the invention, a data processing system configured to run two or more programs in parallel, the data processing system comprising:

at least one processor with a system memory in which two or more programs for controlling said at least one processor are stored;

at least one buffer memory;

an initialization module for generating a source code for a program to be executed at a start of the program to be executed;

an input/output unit for reading data into said at least one buffer memory and/or for writing data into said at least one buffer memory, said input/output unit being configured to store data needed with generation of the source code of the program to be executed in said at least one buffer memory;

an address generator configured to generate, with the storing of the needed data in the at least one buffer memory, at least one address register with a memory content containing addresses of each of the two or more programs in the buffer memory; and

wherein said input/output unit is configured to access said at least one buffer memory from each of the two or more programs via said at least one address register.

In a further embodiment of the invention, a data processing system is also specified on which two or more programs can run in parallel and which has at least one processor with a system memory in which two or more programs for controlling or regulating (i.e., open-loop or closed-loop control) the at least one processor are stored. Furthermore, the data processing system has at least one buffer memory, one initialization module for generating a source code for a program to be executed at the start of the program to be executed, one input/output unit for reading data into the at least one buffer memory and/or for writing data into the at least one buffer memory, which is configured to store data needed with generation of the source code of the program to be executed in the at least one buffer memory, and one address generator. In this context, the address generator is configured to generate, with the storing of the needed data in the at least one buffer memory, at least one address register, the memory content of which are addresses of each of the two or more programs in the buffer memory. The input/output unit is also configured to access the at least one buffer memory from each of the two or more programs via the at least one address register.

Such a data processing system has the advantage that it is configured to provide for a particularly need-oriented access to a buffer memory also from changing processes or programs in a particularly simple manner. Due to the fact that the data processing system is configured to generate, simultaneously with the initialization of a program to be executed, at least one address register from which the basic address of the buffer memory, in which needed data of the program to be executed are stored, can be read, ensures rapid access of the two or more programs to the data stored in the buffer memory in one step. In particular, rapid access of a program to data of a further program section is also ensured. Furthermore, the data processing system is then optimized with regard to resource consumption and computing time. Thus, processors which have a common address and data collection line system, called a bus, execute instructions sequentially. In the case of an internal buffer management via pointers, an instruction address is then placed first on the bus and stored in an address register. Subsequently, the addressed instruction is read into the processor with a time delay depending on the access time of the system memory. During the subsequent execution of these instructions in the processor, data addresses and the data themselves are input or output, respectively, via the same bus. This is associated with a not inconsiderable loading of the bus with instruction addresses which leads to an often considerable time delay of the processing of program sequences. Fast address processing arrangements are also normally used in data processing systems in the form of address registers in information or digital technology, particularly in the area of microcontrollers and designate a database which is intended for inputting addresses, and a database with simple search functions. In this context, the latter can be implemented in a fast and simple manner so that it can be achieved here in a simple manner and without great expenditure.

According to one embodiment, the data processing system is here a preemptive and/or cooperative multitasking data processing system. Operating systems which work in multitasking or multiprocessing mode execute a number of tasks, that is to say a number of processes, concurrently. The methods used as a standard are the cooperative multitasking and the preemptive multitasking in which an operating system core controls the processing of individual processes and stops each process after a particular processing time in favor of other processes. Due to the at least one address register, the data processing system is then configured to ensure that a program which serves for implementing a process can access data of a further process rapidly and promptly even if it has been stopped in favor of other processes. This makes it possible to save resources and computing time compared with an internal memory management via pointers which usually takes place at the precise time when the data are needed. Examples of such preemptive multitasking data processing systems are data processing systems for implementing imaging medical processes in which volumes of data are produced which must be provided in a suitable form to subsequent processing in various programs, for example for evaluation purposes.

According to a further embodiment, the at least one processor can be a multi-core processor. In multi-core processor systems, many processes are divided into tasks. These tasks are processed in parallel by a number of processer cores. In this arrangement, situations may occur in which a task is dependent on another task, that is to say situations in which a program which is used for implementing a task must access the data of a further program processed on a processor core of the multi-core processor. In this arrangement, the data processing system, due to the use of the at least one address register, is configured again to ensure fast and prompt access to these data and it is again possible to save resources and computing time in comparison with an internal memory management via pointers.

The data processing system can also have a real-time operating system. In a real-time system, a number of tasks run with different priorities, as a rule, and must be executed promptly. In consequence, it is necessary especially in real-time operating systems and real-time operating system cores that the communication of programs running on the data processing system, that is to say the tasks, takes place promptly and quickly, especially that the individual programs can access the data of further programs rapidly and reliably without delays occurring during this process.

Furthermore, the data processing system can have context memories in which the at least one address register is stored and which are accessed by the two or more programs. It is a characteristic of a process that a process always accesses its own memory area. A process consists of a number of threads which are program sections of a process. A context of a thread is the processor status of a processor which processes this thread or program commands of this thread, respectively. Accordingly, the context of a thread is defined as a temporary processor status during the processing of the thread by this processor. The context is held by the hardware of the processor, namely the program counting register or program counter, respectively, the register file or the context memory, respectively, and the associated status register. The data processing system is thus configured in such a manner that the individual programs running on the data processing system access the external memory and the at least one address register independently of the selected operating mode or the selected operating system. It is then possible to access the memory unit, that is to say the at least one buffer memory, directly via the at least one address register. This requires correspondingly fewer clock steps and, therefore, accelerates further the access of the two or more programs of the at least one buffer memory.

The at least one buffer memory can be constructed of buffer rows in this context. Furthermore, the input/output unit can be configured for writing the same Pdata into the same buffer row from each of the two or more programs. The data processing system can thus be configured in such a manner to ensure memory coherence. Ensuring coherence prevents different, inconsistent data from being delivered back for the same memory address. In this context, buffer memories use blocks of data called a buffer row which are almost always a multiple of a word width of the processor and frequently even a multiple of the width of the bus system connecting the processors to a system memory.

In addition, the input/output unit can be configured to store a content of the at least one buffer memory in the system memory after completion of the program to be executed. This can ensure that in the case of a restart of the corresponding program, the individual program sections, that is to say the associated program data, are present in the data processing system in the last version used, the bus being able to be used between processor and system memory without producing a not inconsiderable loading of the bus.

By means of a further embodiment of the invention, a control device for a motor vehicle is also specified which has a data processing system described above. Thus, more and more control devices of a motor vehicle are formed by processor cores of multi-core processors which provide the functions of the control device. In this arrangement, for example, situations may occur in which a control program of a processor core is dependent on an initial size of another processor core and, in consequence, a rapid and prompt access to these data must be ensured.

In summary, it is found that with the present invention, a method for operating a buffer memory of a data processing system and a data processing system are specified by means of which a particular need-oriented access to a buffer memory is made possible also from changing processes or programs in a particularly simple manner.

Since, at the same time as the initialization of a program to be executed, at least one address register is generated, from which the basic address of the buffer memory, in which needed data of a program to be executed are stored, can be read out, a fast and prompt access to these data can be ensured, it being possible to save resources and computing time compared with an internal buffer management via pointers.

In this context, coherence can also be ensured in that the data processing system is configured in such a manner that the two or more programs in each case write the same data into the same buffer row of the buffer memory.

Other features which are considered as characteristic for the invention are set forth in the appended claims.

Although the invention is illustrated and described herein as embodied in a method for operating a buffer memory of a data processing system and a data processing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of a data processing system according to an exemplary embodiment of the invention; and

FIG. 2 is a flow chart of a method for operating a buffer memory of a data processing system according to an embodiment of the invention.

### DETAILED DESCRIPTION OF THE INVENTION

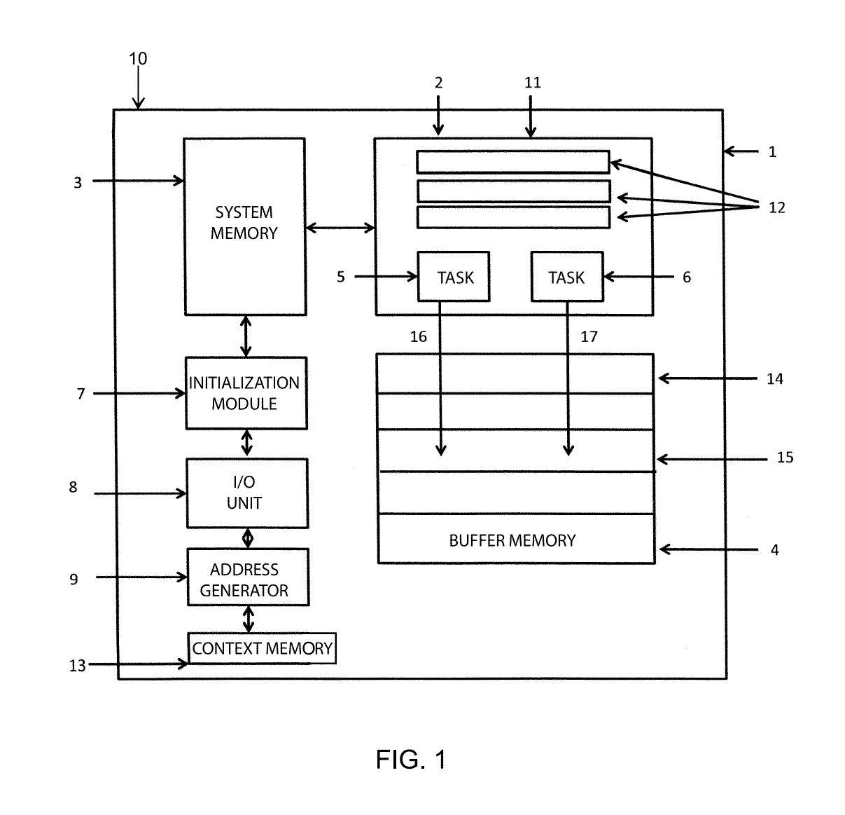

Referring now to the figures of the drawing in detail and first, particularly, to FIG. 1 thereof, there is shown a block diagram of a data processing system 1 according to an exemplary embodiment of the invention.

In the data processing system 1 according to FIG. 1, it is provided that a number of processes, so-called tasks, are called up and processed by an operating system. For this purpose, the data processing system 1 according to FIG. 1 has a processor 2 with a system memory 3 in which two or more programs for controlling or regulating (i.e., closed-loop controlling) the processor 2 are stored. Furthermore, a buffer memory 4 can be seen which is designed as a fast memory. In such a buffer memory 4, data are stored temporarily, especially needed program sections or data of a program to be executed.

A task 5, 6 usually consists of a task control block, a program section and a data section. The term data section of task 5, 6 is to be understood in such a manner that task 5, 6 has access to these data. The data section can comprise both “private” data which are only allocated to a task 5, 6 determined in each case, and “common” data, or a memory-mapped input/output data area. To process an entire program, a number of tasks 5, 6 are intended to be used usually in parallel for achieving various part-tasks, storing in each case their data calculated or determined in another manner in their own data area.

In this context, situations may occur in which a task 5, that is to say a program which is used for implementing the task 5, is dependent on the data of another program which is used for implementing another task 6 and, in consequence, must access this buffer memory 4. Usually, an internal buffer management via pointers is provided for this purpose which can lead to a not inconsiderable loading of a databus or data processing system and in consequence to a considerable time delay of the processing of program sequences and to an increased consumption of resources.

According to FIG. 1, an initialization module 7 for generating a source code for a program to be executed at the start of the program to be executed, an input/output unit 8 for reading data in the buffer memory 4 and/or for writing data into the buffer memory 4, which is configured to store data, needed with the generation of the source code, of the program to be executed in the buffer memory 4, and an address generator 9 are also provided in this arrangement, the address generator 9 being configured to generate with the storing of the needed data in the buffer memory 4 at least one address register, the memory content of which are addresses of each of the two or more programs on the buffer memory 4 and the input/output unit 8 being configured to access the buffer memory 4 from each of the two or more programs via the at least one address register.

The data processing system 1 according to FIG. 1 is here a preemptive multitasking data processing system 10. Operating systems which operate in multitasking or multi-process mode execute a number of tasks, that it so say a number of tasks 5, 6, concurrently. Furthermore, the data processing system can also be a cooperative multitasking data processing system, however. The methods used as a standard are in this context the cooperative or the preemptive multitasking in which an operating system core controls the processing of the individual tasks 5, 6 and stops each task 5, 6 in favor of other tasks 5, 6 after a particular processing time.

As can also be seen, the processor 2 is here configured as a multi-core processor 11. In multi-core processor systems, many programs are divided into tasks 5, 6 which are processed in parallel by a number of processor cores 12. In this context, a multi-core processor 11 can usually comprise from two up to several hundred processor cores, three processor cores 12 being shown in FIG. 1 which in each case process one task 5, 6.

Furthermore, the operating system according to FIG. 1 is a real-time operating system. In a real-time system, a number of tasks 5, 6 run at different priorities, as a rule, and must be executed promptly. In consequence, it is necessary particularly in real-time operating systems and real-time operating system cores that the communication of tasks 5, 6 running on the data processing system take place promptly and rapidly, in particular, that the individual tasks 5, 6 can access data of other tasks 5, 6 rapidly and reliably.

As can also be seen, the data processing system 1 according to FIG. 1 comprises context memory 13, into which the at least one address register is stored and which can be accessed by the two or more programs. It is a characteristic of a process that a process always accesses its own memory area. A process consists of a number of threads which are program sections of a process. A context of a thread is the processor status of a processor which processes this thread or program commands of this thread, respectively. Accordingly, the context of a thread is defined as a temporary processor status during the processing of the thread by this processor. The context is held by the hardware of the processor, namely the program counting register or program counter, respectively, the register file or the context memory respectively, and the associated status register.

In this arrangement, the buffer memory 4 shown is constructed of buffer rows 14. Furthermore, the input/output unit 8 shown is configured to write the same data from each of the two or more programs into the same buffer row 15 which is symbolized by the arrows designated by reference symbols 16 and 17. By this means, a memory coherence can also be ensured since it is prevented that different, inconsistent data are delivered back for the same memory address.

Furthermore, the input/output unit 8 of FIG. 1 is configured to store a content of the buffer memory 4, after completion of the program to be executed, in the system memory 3 which ensures that in the case of a restart of the corresponding program, the individual program sections, that is to say the associated program data, are present in the last version used.

In this arrangement, the data processing system 1 of FIG. 1 is configured, in particular, to implement the functions of a control device of a motor vehicle.

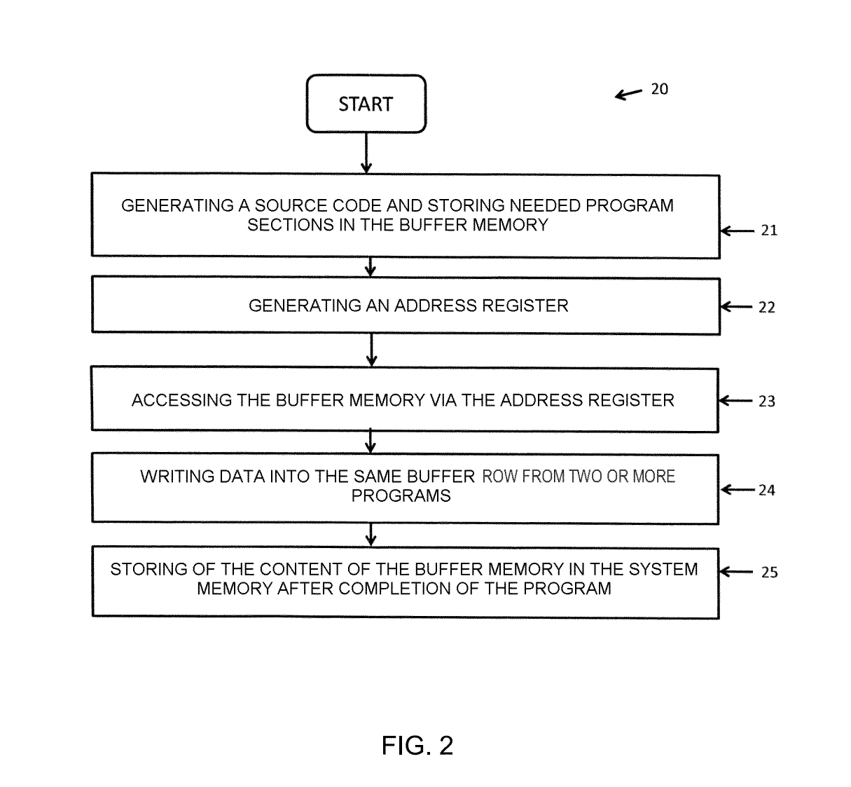

FIG. 2 shows a flow chart of a method 20 for operating a buffer memory of a data processing system according to embodiments of the invention. In this arrangement, two or more programs can run in parallel on this data processing system.

As is shown in FIG. 2, the method 20 exhibits the following steps: thus, a source code for a program to be executed is generated first in a step 21 and needed data of the program to be executed are stored in the buffer memory.

At the same time, at least one address register, the memory content of which are addresses of each of the two or more programs in the buffer memory, is generated in a step 22. In a subsequent step 23, the two or more programs access the buffer memory via the at least one address register.

According to embodiments of FIG. 2, the data processing system is again a preemptive and/or a cooperative multitasking data processing system.

The system also comprises a multi-core processor.

Furthermore, the data processing system according to FIG. 2 has a real-time operating system.

In the method 20 according to FIG. 2, the at least one address register is stored in the context memory which is accessed by the two or more programs.

As is shown in FIG. 2, the method 20 has the further step 24 that the buffer memory is built up of buffer rows and the two or more programs can access the buffer memory in reading and/or writing mode, in such a manner that the same data are in each case written into the same buffer row from the two or more programs. This again ensures a memory coherence. Ensuring coherence prevents different, inconsistent data from being delivered back from the same memory address.

FIG. 2 also shows step 25, that a content of the buffer memory is written into a system memory of the data processing system after completion of the program to be executed. This makes it possible to ensure that in the case of a restart of the corresponding program, the individual program sections, that is to say the associated program data, are present in the last version used in the data processing system.

The following is a summary list of reference numerals and the corresponding structure used in the above description of the invention:
1 Data processing system
2 Processor
3 System memory
4 Buffer memory
5 Task
6 Task
7 Initialization module
8 Input/output unit
9 Address generator
10 Preemptive multitasking data processing system
11 Multi-core processor
12 Processor cores
13 Context memory
14 Buffer rows
15 Buffer row
16 Writing process
17 Writing process
20 Method
21-25 Method steps

1. A method of operating a buffer memory of a data processing system that is configured to run two or more programs in parallel, the method comprising the following steps:
generating a source code for a program to be executed and storing needed data of the program to be executed in the buffer memory;
simultaneously generating at least one address register, the memory content of which are addresses of each of the two or more programs in the buffer memory; and
accessing the two or more programs in the buffer memory via the at least one address register.

2. The method according to claim 1, wherein the data processing system is a preemptive and/or cooperative multitasking data processing system.

3. The method according to claim 1, wherein the data processing system comprises a multi-core processor.

4. The method according to claim 1, wherein the data processing system has a real-time operating system.

5. The method according to claim 1, wherein the at least one address register is stored in a context memory which is accessed by the two or more programs.

6. The method according to claim 1, wherein the buffer memory is constructed of buffer rows and the two or more programs can access the buffer memory with a reading and/or writing process, such that the same data from the two or more programs are in each case written into the same buffer row.

7. The method according to claim 1, which comprises writing a content of the buffer memory into a system memory of the data processing system after completion of a program to be executed.

8. A data processing system configured to run two or more programs in parallel, the data processing system comprising:
at least one processor with a system memory in which two or more programs for controlling said at least one processor are stored;
at least one buffer memory;
an initialization module for generating a source code for a program to be executed at a start of the program to be executed;
an input/output unit for reading data into said at least one buffer memory and/or for writing data into said at least one buffer memory, said input/output unit being configured to store data needed with generation of the source code of the program to be executed in said at least one buffer memory;
an address generator configured to generate, with the storing of the needed data in the at least one buffer memory, at least one address register with a memory content containing addresses of each of the two or more programs in the buffer memory; and
wherein said input/output unit is configured to access said at least one buffer memory from each of the two or more programs via said at least one address register.

9. The data processing system according to claim 8, configured as a preemptive and/or cooperative multitasking data processing system.

10. The data processing system according to claim 8, wherein said at least one processor is a multi-core processor.

11. The data processing system according to claim 8, configured as a real-time operating system.

12. The data processing system according to claim 8, further comprising context memories in which the at least one address register is stored and which are accessed by the two or more programs.

13. The data processing system according to claim 8, wherein said at least one buffer memory is constructed of buffer rows and said input/output unit is configured for writing the same data into said same buffer row from each of the two or more programs.

14. The data processing system according to claim 8, wherein said input/output unit is configured to store a content of said at least one buffer memory in the system memory after completion of the program to be executed.

15. A control device for a motor vehicle, comprising a data processing system according to claim 8.
